(19) United States
(12) Patent Application Publication
(10) Pub. No.: US 2010/0274613 A1
(43) Pub. Date: Oct. 28, 2010

(54) REFERRAL SENDING, TRACKING AND MANAGEMENT SYSTEM

(76) Inventor: Jordan Wexler, Sherman Oak, CA (US)

Correspondence Address: John Alumit, 16830 Ventura Blvd. Suite 360, Encino, CA, 91436, US

(21) Appl. No.: 12/478,466

(22) Filed: Jun. 4, 2009

Related U.S. Application Data
(60) Provisional application No. 61/172,619, filed on Apr. 24, 2009.

(51) Int. Cl. G06Q 10/00; G06F 3/01

(52) U.S. Cl. 705/8; 715/739

(57) ABSTRACT

A referral sending, tracking and management system for generating, exchanging and managing local referrals based on an input from at least one member in a business network is disclosed. The system comprises a means for searching at least one member, a means for sending referrals to at least one member, a means for receiving referrals from at least one member and at least one referral center for managing all stages of referrals from origination to completion. The system provides full accountability of the status and stages of all referral lead between each member. Each member may access profiles of all members in the business network through links provided in the webpage. Each member in the business network may be from a group of local business professionals and service providers.

### CROSS-REFERENCE TO RELATED APPLICATION

This application claims the benefits of the priority date of provisional application 61/172,619 filed on Apr. 24, 2009

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to referral management, and more particularly to an automated system and method for generating, exchanging and managing local referrals based on an input from at least one member in a business network.

An act of recommendation to consult a person or a group of persons to whom one has been directed or referred for availing a particular service can be termed as a referral. Referral leads are obtained through the referral of an existing customer or through a direct response to advertising. Business professionals have been sending referrals verbally or by writing a referral note on a piece of paper. Such a practice often fails to provide any form of accountability as to whether the particular referral was sent or not. In addition, it requires a centralized process for managing the bulk of referrals received. Online referral sending is gaining popularity and resolves most of the problems associated with the former practices.

Various systems and methods have been developed in art for managing referrals. For example, U.S. Pat. No. 6,968,313 issued to Oran on Nov. 22, 2005 facilitates and tracks personal referrals made via electronic network. Using electronic mail delivered to a participant interface, a central controller provides a webpage through which an individual may enter the electronic mail address of those whom he or she wishes to refer. The address or content of the webpage includes a unique identifier that is exclusively associated with that individual and a specific offer. In this way, the series of referrals may be tracked, duplicate referrals to the same electronic mail address may be eliminated, offer may be withdrawn or modified, and referrals about an expired or withdrawn offer may be prevented. This has the disadvantage that a person is devoid of his opportunity to search for professionals.

Likewise, U.S. Pat. No. 6,968,513 issued to Rinebold on Nov. 22, 2005 discloses an online interactive system comprising a business referral and income generation system linked to one or more listed web sites of businesses in a particular locality or geographical area. Revenue is generated by way of such methods as: merchants listing their web sites in one or more web site directories for multiple communities; banner ads; local and national coupons issued by merchants; classified job listings; classified realty listings; “4 Sale” ads; and fees for supplemental services called “Extended Services” serving to provide interactive capabilities to static web sites. Such a system fails to provide a customer an option to select professionals belonging to a particular category. In addition, searching professionals extending from the local area is impossible.

U.S. Pat. No. 6,513,013 issued to Stephanou on Jan. 28, 2003 teaches a system and method for assigning an expert to a request for assistance including real time interaction. The invention allows users to request assistance over the Internet to an expert server having a file of qualified experts. The trouble “ticket” is assigned and alias is sent out to a number of experts having the correct qualifications who then have an opportunity to respond. The first to respond is assigned an alias and communicates in real time with the requester via the expert server. Upon completion of the ticket, the expert so designates and the requester is asked to fill out a survey noting the satisfaction with the service provided. Here the user is not given an option for selecting a particular professional among all the available ones. Moreover, the user is unable to see a detailed profile of the available professionals.

U.S. Pat. No. 6,457,005 to Torrey on Sep. 24, 2002 discloses methods that record in a database the descriptions of opportunities and the terms under which referral fees will be paid to parties that refer resources for consideration. In one application, opportunities are employment openings and resources are potential employees. Parties may search the database to discover opportunities along with the related referral-fee information, and may submit a referral that includes information describing a resource for consideration to satisfy an opportunity described in the database. A subsequent trigger event, such as a referred person being hired, initiates activities that allow a referring party to receive the referral fees that are due under the terms that are recorded in the database. This method fails to provide option for searching professionals in a local area.

It is therefore, an object of the present invention to provide an automated system for generating, exchanging and managing referrals based on an input from at least one member in a business network. Another object of the invention is to provide options for searching professionals belonging to a particular category. A further object of the invention is to provide options for searching professionals in a local area as well as extending to a wide area. Other objects of the present invention will become better understood with reference to appended Summary, Description and Claims.

### SUMMARY

The present invention is a referral sending, tracking and management system for generating, exchanging and managing local referrals based on an input from at least one member in a business network. The system comprises a means for searching at least one member, a means for sending referrals to at least one member, a means for receiving referrals from at least one member and at least one referral center for managing all stages of referrals from origination to completion. The system provides full accountability of the status and stages of all referral leads between each member in the business network. Each member in the business network may be from a group of local business professionals and service providers.

At least one member logs into a website through the Internet with a unique email address and a password for accessing respective member area. The member in the business network accesses the summary of a plurality of received referrals and a plurality of sent referrals by selecting links entitled referrals received and referrals sent respectively in the referral center.

A referee acknowledges at least one of acceptance and rejection of the referral to a referrer by clicking on save button after changing the referral lead status and adding a note for the referrer. When the save button is clicked, the updated information is saved in the referrals received area of the referee, and the referral sent area of the referrer.

The referrer examines available services to see a list of categories covered by at least one or both of local member business professionals and service providers in referrer's local area. The referrer selects a category, a subcategory and a zip code to search for at least one or both of local member business professionals and service providers. The referrer sends the referral after filling the referral details. Each member may access profiles of all members in the business network through links provided in the webpage.

Although particular embodiments of the present invention have been described in the foregoing description, it is to be understood that the present invention is not to be limited to just the embodiments disclosed, but that they are capable of numerous rearrangements, modifications and substitutions without departing from the description herein.

### FIGURES

FIG. 1 is a diagrammatic representation of a system for generating, exchanging and managing local referrals based on an input from at least one member in a business network.

FIG. 2 is an operational flow chart of the invention, illustrating a method for acknowledging at least one of acceptance and rejection of a referral by a referee.

FIG. 3 is an operational flow chart of the invention, illustrating a method for sending a referral to a referee.

FIG. 4 is a detailed flow chart of the invention, illustrating at least one member in a business network logged into a member area and sending a referral for his customer.

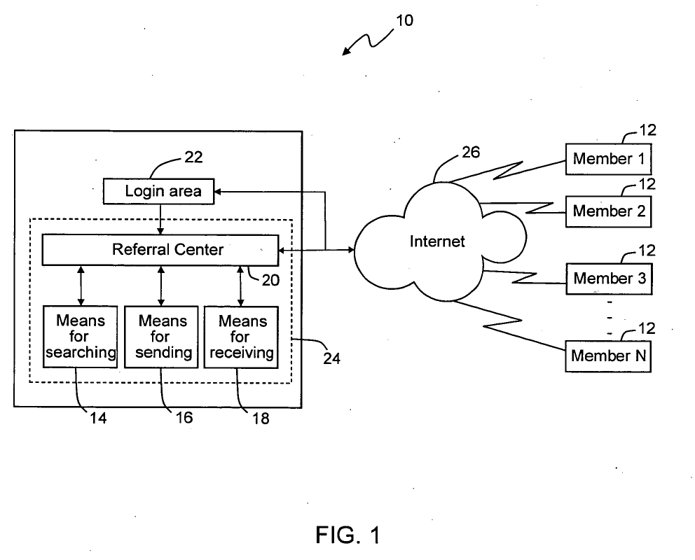

The following reference numeral are represented in FIGS. 1 through 4:
10 . . . referral sending, tracking and management system
12 . . . a member in a business network
14 . . . a means for searching
16 . . . a means for sending
18 . . . a means for receiving
20 . . . referral center
22 . . . login area
24 . . . member area
26 . . . Internet
30 . . . an operational flow chart illustrating a method for acknowledging at least one of acceptance and rejection of a referral to a referrer by a referee
32 . . . referee logging into his member area
34 . . . referee entering a referral center and selecting a link next to referrals received
36 . . . referee selecting an icon next to title of at least one of the referrals received
38 . . . referee changing the referral lead status and adding a note
40 . . . clicking on “Save” button
50 . . . an operational flow chart illustrating a method for sending a referral to a referee
52 . . . referrer logging into his member area
54 . . . referrer entering referral center
56 . . . referrer examining available services
58 . . . referrer selecting a category, a subcategory and a zip code
60 . . . referrer selecting at least one or all of retrieved local member business professionals and service providers
62 . . . referrer sending referral
70 . . . an operational flow chart illustrating at least one member in a business network logging into his member area and sending a referral for his customer
72 . . . customer asking for referral
74 . . . member logging into his member area
76 . . . update profile
78 . . . referral center
80 . . . affiliate center
82 . . . view referrals received
84 . . . view referrals sent
86 . . . member viewing received referrals
88 . . . member viewing sent referrals
90 . . . member viewing received referral details
92 . . . member viewing sent referral details
94 . . . member examining available services
96 . . . member searching local members
98 . . . member conducting extended search
100 . . . checking availability of members providing service
102 . . . selecting category, sub-category and zip code
104 . . . listing at least three different referrals
106 . . . viewing profiles of each referral sources
108 . . . filling in information on referral

### DESCRIPTION

Referring to the drawings, a preferred embodiment of an automated referral sending, tracking and management system 10 for generating, exchanging and managing local referrals based on an input from at least one member 12 in a business network. Referring to FIG. 1, a diagrammatic representation of a referral sending, tracking and management system 10 comprises a means for searching at least one member 14, a means for sending referrals to at least one member 16, a means for receiving referrals from at least one member 18 and at least one referral center 20 for managing all stages of referrals from origination to completion. The system 10 provides full accountability of the status and stages of all referral leads between each member 12 in the business network. Each member 12 in the business network is at least one of local business professionals and service providers.

At least one member 12 in the business network logs into a website in a login area 22 with a unique email address and a password for accessing respective member area 24. The member 12 accesses the website through Internet 26. A summary of received referrals and sent referrals between a referee and a referrer who are members 12 in the business network are displayed in respective member area 24. The referrer sends referrals to at least one of local business professionals and service providers who are located within a zip code. Each zip code is divided into a plurality of categories of professionals.

The system 10 further provides the referrer full accountability of the status of referrals send to at least one referee in the business network who is currently unavailable. The member 12 is notified of at least one or both of an inbound referral and a change in referral lead status through an email by a computer, a cell phone, a personal digital assistant and the like. The member 12 views the total number of referrals received and sent from the referral center 20. The member 12 further views the referrals with a status of active/unread from the referral center 20. The member 12 in the business network accesses the summary of a plurality of received referrals and a plurality of sent referrals by selecting links entitled referrals received and referrals sent respectively in the referral center 20.

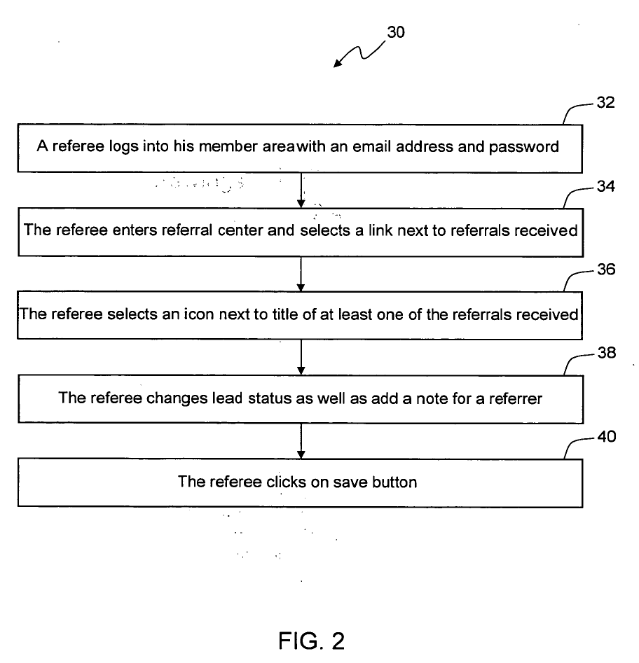

With reference to FIG. 2, an operational flow chart 30 illustrates a method for acknowledging at least one of acceptance and rejection of a referral to a referrer by a referee. The referee logs into his member area with an email address and password as indicated in step 32. The referee enters a referral center and selects a link next to referrals received as indicated in step 34. The referee checks a summary of a plurality of referrals received that may include title, name of referrer, status of referral and date sent of each referral. The referee selects an icon next to title of at least one of the referrals received as indicated in step 36, to see details of the received referrals. The details may include fields such as referrer's name, category, zip code, contact name, business name, location, business phone, residence phone, budget, referral lead title, referral lead description and notes about the referral. The referee changes the referral lead status and adds a note to inform the referrer about his response on the received referral as indicated in step 38. The referee clicks on save button as indicated in step 40 to save updated information in referrals received area of the referee and referral sent area of the referrer.

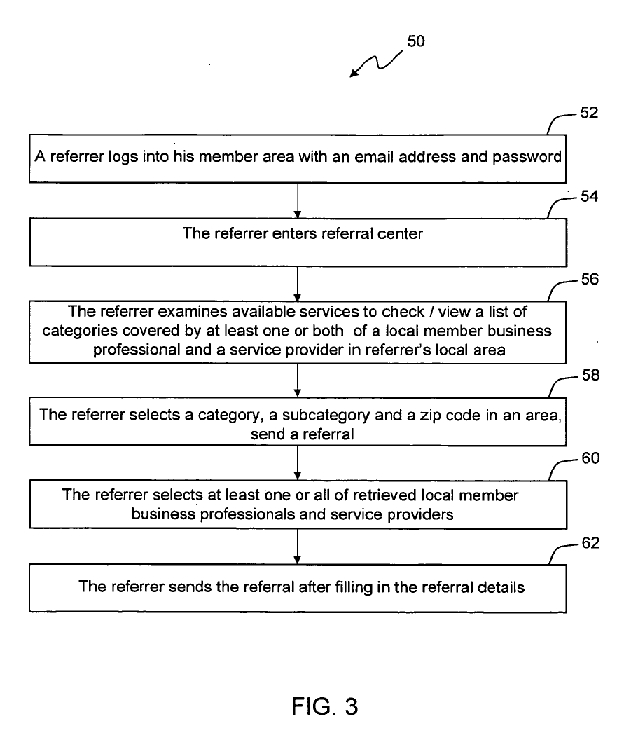

With reference to FIG. 3, an operational flow chart 50 illustrates a method for sending a referral to a referee. The referrer logs into his member area with an email address and password as indicated in step 52. The referrer enters the referral center as indicated in step 54. The referrer examines available services to see a list of categories covered by at least one or both of local member business professionals and service providers in referrer's local area as indicated in step 56. The referrer selects a category, a subcategory and a zip code in the area, send a referral, as indicated in step 58. The referrer selects at least one or all of retrieved local member business professionals and service providers as indicated in step 60. The referrer sends the referral after filling in the referral details as indicated in step 62. At least one member in the business network may access profiles of all members in the business network through links provided in the webpage.

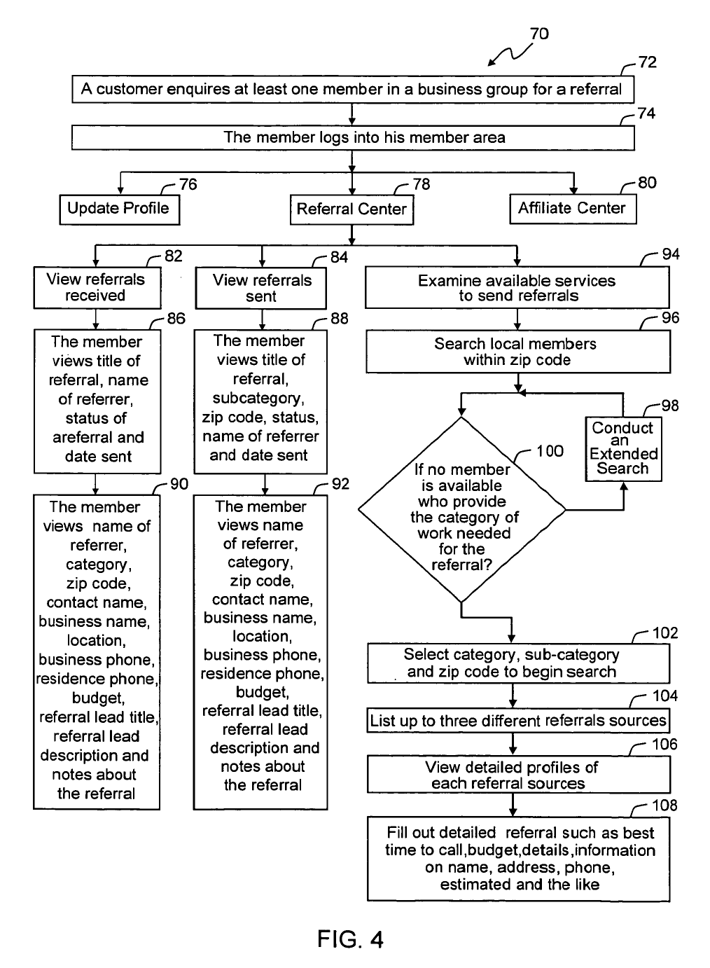

FIG. 4 is a detailed flow chart 70 that illustrates at least one member in the business network logging into his member area and sending referral for his customer. The customer enquires the member for a referral as indicated in step 72. The member logs into his member area through his online account as indicated in step 74. The member enters into at least one of the links entitled update profile, referral center and affiliate center. The member accesses the summary of the plurality of received referrals and the plurality of sent referrals by selecting links entitled referrals received and referrals sent respectively as indicated in step 82 and 84. The member views the title of referral, name of referrer, status of the referral and date referral referral is sent upon selecting the link, referrals received as indicated in step 86. The member views title of referral, sub-category, zip code, status, name of referrer and date sent upon selecting the link, referrals sent as indicated in step 88. The member views name of at least one of referrer and referee, category, zip code, contact name, business name, location, business phone, residence phone, budget, referral lead title, referral lead description and notes about the referral upon selecting the icon next to title of each referral as indicated in steps 90 and 92.

The member examines the available services as indicated in step 94. The member searches a list of categories covered by at least one or both of business professionals and service providers within referrer's zip code as indicated in step 96. The member selects a link entitled view extended to see all members in the business network in an extended range, when there are no members providing a category of work needed for the referral as indicated in steps 98 and 100. The member selects category, sub-category and zip code to begin search as indicated in step 102.

The search provides at least three different referees as indicated in step 104. The member is further given a provision to view detailed profiles of each referee as indicated in step 106. The member fills out detailed information on the referral such as name of referrer, address, best time to call, phone, estimated budget, details, and the like as indicated in step 108. The member in the business network sends the referral by an electronic data entry input device such as a mouse, a keyboard, or the like.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An automated system for generating, exchanging and managing local referrals based on an input from at least one member in a business network, the system comprising:
a means for searching at least one member;
a means for sending referrals to the at least one member;
a means for receiving referrals from the at least one member; and
at least one referral center for managing all stages of referrals from origination to completion;
whereby the system provides full accountability of the status and stages of all referral leads between each member in the business network, each member is at least one of local business professionals and service providers.

2. The system of claim 1, wherein referrals are sent to at least one of local business professionals and service providers who are located within a zip code, each zip code being divided into a plurality of categories of professionals.

3. The system of claim 1, wherein at least one member logs into a website with a unique email address and a password for accessing respective member area.

4. The system of claim 1, wherein a summary of received referrals and sent referrals between a referee and a referrer in the business network are displayed in respective member area.

5. The system of claim 1, wherein at least one referrer has full accountability of the status of referrals send to at least one referee in the business network who is currently unavailable.

6. The system of claim 1, wherein the at least one member is notified of at least one or both of an inbound referral and a change in lead status through an email by a computer, a cell phone, a personal digital assistant and the like.

7. The system of claim 1, wherein at least one member views the total number of referrals received and sent thereof from the referral center, including the referrals with a status of active/unread.

8. The system of claim 1, wherein at least one member may access a summary of a plurality of received referrals and a plurality of sent referrals by selecting links entitled referrals received and referrals sent respectively in the referral center.

9. A method for acknowledging at least one of acceptance and rejection of a referral send to a referrer by a referee, the method comprising:
logging into a member area with an email address and password;
entering a referral center and selecting a link next to referrals received to check a summary of a plurality of referrals received;
selecting an icon next to title of at least one of the referrals received to navigate to details thereof;
changing lead status as well as adding a note to inform the referrer about the response of the received referral; and
clicking save button to save updated information in referrals received area of the referee and referral sent area of the referrer.

10. The method of claim 9, wherein at least one member selects the link next to referrals received to check the summary of the referrals received may include title, name of the referrer, status of the referral and date sent of each referral.

11. The method of claim 9, wherein at least one member selects an icon next to title of each received referral in the referral received area to view referral details that includes a plurality of fields such as referrer's name, category, zip code, contact name, business name, location, business phone, residence phone, budget, referral lead title, referral lead description and notes about the referral.

12. A method for sending a referral to a referee in a business network, the method comprising:
logging into a member area with an email address and password;
entering a referral center;
examining available services to see a list of categories covered by at least one or both of a local member business professional and a service provider in referrer's local area;
selecting a category, a subcategory and a zip code in the area. send a referral;
selecting at least one or all of retrieved local member business professionals and service providers; and
sending the referral after filling the referral details.

13. The method of claim 12, wherein at least one member selects a link entitled view extended to see all members in the business network in an extended range, when there are no members providing a category of work needed for the referral.

14. The method of claim 12, wherein at least one member in the business network selects a link entitled referrals sent to check summary of the referrals sent including title, subcategory, zip code, status, name of referee and date send.

15. The method of claim 12, wherein at least one member clicks on an icon located next to title in the referral sent area to check the status of referrals sent.

16. The method of claim 12, wherein at least one member sends the referral by an electronic data entry input device.

17. The method of claim 12, wherein at least one member may access profiles of all members in the business network through links provided in the webpage.
